(19) United States
(12) Patent Application Publication
(10) Pub. No.: US 2026/0242399 A1
(43) Pub. Date: Aug. 20, 2026

(54) AMINO-FUNCTIONALIZED POLYSILOXANE COMPOUND AND USE THEREOF, AND ELECTROCHEMICAL ENERGY STORAGE DEVICE USING SAME AS ELECTROLYTE SOLUTION

(71) Applicant: GUANGZHOU INSTITUTE OF ENERGY CONVERSION, CHINESE ACADEMY OF SCIENCES, Guangdong (CN)

(72) Inventors: Lingzhi ZHANG, Guangdong (CN); Xiaodan YAN, Guangdong (CN)

(73) Assignee: GUANGZHOU INSTITUTE OF ENERGY CONVERSION, CHINESE ACADEMY OF SCIENCES, Guangdong (CN)

(21) Appl. No.: 18/995,153

(22) PCT Filed: Jul. 21, 2023
(86) PCT No.: PCT/CN2023/108678

§ 371 Date: Jan. 16, 2025

(30) Foreign Application Priority Data
Oct. 19, 2022 (CN) 202211276835.0

(51) Int. Cl. C07F 7/08; H01M 10/0525; H01M 10/26

(52) U.S. Cl. CPC C07F 7/0879; H01M 10/0525; H01M 10/26

(57) ABSTRACT

An amino-functionalized polysiloxane compound and a use thereof, and electrochemical energy storage devices using the same as an electrolyte solution are provided. The amino-functionalized polysiloxane compound represented by formula (I) and an electrolyte solution comprising the compound,

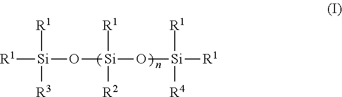

wherein n is an integer of 1-4, R¹ is selected from any one of C1-C5 alkyl and alkoxy; R², R³ and R⁴ are selected from alkyl, alkoxy, —(CH₂)₃(OCH₂CH₂)ₓN(CH₃)₂, wherein x is 1-3, and R², R³ and R⁴ must have a group selected from —(CH₂)₃(OCH₂CH₂)ₓN(CH₃)₂.

### TECHNICAL FIELD

The present invention relates to the field of electrochemical energy storage technology, and in particular to an amino-functionalized polysiloxane compound and a lithium ion battery, a sodium ion battery, a potassium ion battery, a lithium sulfur battery or a supercapacitor containing the compound.

### DESCRIPTION OF RELATED ART

In recent years, lithium ion battery have been widely used in portable electronic products such as digital cameras, mobile phones, and laptops. Lithium cobalt oxide (LiCO2, abbreviated as LCO) is the earliest commercialized positive electrode material for lithium ion battery and the most widely used positive electrode material in the consumer electronics market. However, the capacity of conventional lithium cobalt oxide battery is only 140 mAh/g, which is about 50% of its theoretical capacity. With the increasing requirements for the battery life and volume of consumer electronic products, especially 5G mobile phones, there is an urgent need to further improve the volume energy density of battery. Increasing the voltage (above 4.5 V) is an effective way to increase the capacity of lithium cobalt oxide battery, but it will lead to a decrease in the stability of lattice oxygen in lithium cobalt oxide materials, causing oxidative decomposition of the electrolyte, thereby reducing the cycle stability of the battery. In addition, due to the increase in nickel content, the cycle stability and safety of high-nickel ternary positive electrode materials (NCM) are greatly reduced. Therefore, how to improve the long-term cycle stability of high-voltage lithium cobalt oxide and high-nickel ternary battery is a major challenge we face.

Using electrolyte additives to form electrolyte films in situ at the initial stage of battery charge and discharge is an effective method to improve the stability of lithium ion battery. A stable surface film is conducive to inhibiting the dissolution of metal ions in the positive electrode material, thereby improving the cycle performance of the battery. In this case, functionalized organosiloxane compounds have the advantages of excellent thermal stability, non-toxicity, low flammability and high decomposition voltage, and good compatibility with electrode materials. They can be used as electrolyte additives and are easy to form films on the surface of electrode materials. Compared with the currently commercialized carbonates, they have better safety, so they have great commercial application prospects in electrochemical energy storage devices.

### SUMMARY

An object of the present invention is to provide an amino-functionalized polysiloxane compound and an electrolyte containing the compound.

The present invention is achieved through the following technical solutions:

An amino-functionalized polysiloxane compound represented by formula I:

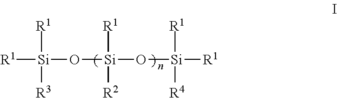

wherein n=an integer of 1 to 4, R¹ is selected from any one of C1-C5 alkyl or alkoxy; R², R³ and R⁴ are selected from alkyl, alkoxy, —(CH₂)₃(OCH₂CH₂)ₓN(CH₃)₂, wherein x=1-3, and R², R³ and R⁴ must have a group selected from —(CH₂)₃(OCH₂CH₂)ₓN(CH₃)₂.

A preparation method of the above-mentioned amino-functionalized polysiloxane compound includes the following steps: under the protection of an inert gas, a double-bond compound containing an amino group and polysiloxane are subjected to a hydrosilylation reaction under the action of a catalyst, the reaction temperature is 45-130° C., the reaction time is 4-24 hours, the molar ratio of the double-bond compound containing an amino group to the polysiloxane is 1:1.0-1.2; the polysiloxane is 1,1,1,3,3-pentamethyldisiloxane or 1,1,3,3,5,5,5-heptamethyltrisiloxane, 1,1,1,3,3-pentamethyldisiloxane; the hydrosilylation catalyst is selected from chloroplatinic acid or Karstedt's catalyst, and the amount added is 0.1-1 mol equivalent of the double-bond compound containing an amino group. The double-bond compound containing an amino group is 2-(allyloxy)-N,N-dimethylethylamine or 2-(allyloxy)ethoxy-N,N-dimethylethylamine.

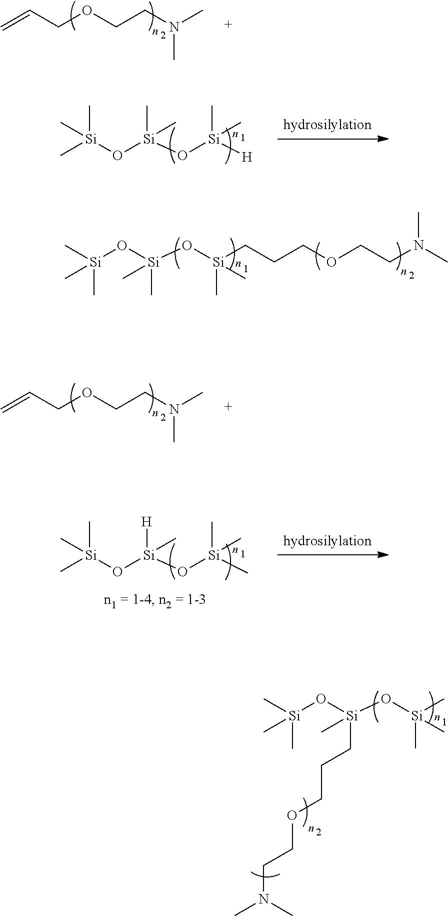

The amino-functionalized polysiloxane compound prepared by the present invention has high safety and thermal stability of organic silicon materials, and the introduction of amino-functionalized groups makes the polysiloxane compound according to the present invention more conducive to forming a stable Chemical-Electrochemical Interface (CEI) film on the surface of the electrode material, blocking the direct contact between the surface of the electrode material and the electrolyte, effectively inhibiting the oxidative decomposition of the electrolyte, improving the stability of the active material structure, and inhibiting the dissolution of transition metal ions on the surface of the material, thereby effectively improving the cycle performance of the battery at high temperature/high pressure.

The present invention also protects an application of the amino-functionalized polysiloxane compound as a lithium ion battery electrolyte material.

The lithium ion battery electrolyte includes a lithium salt, an organic solvent and the amino-functionalized polysiloxane compound.

The lithium ion battery electrolyte includes a lithium salt, an organic solvent and the amino-functionalized polysiloxane compound; the concentration of the lithium salt in the electrolyte is 0.5-1.5 mol/L, and the amount of the amino-functionalized polysiloxane compound used is 0.1-5% of the total mass of the lithium salt and the solvent; the organic solvent is selected from one or more of ethylene carbonate, dimethyl carbonate, ethyl methyl carbonate, diethyl carbonate, propylene carbonate, fluoroethylene carbonate, ethyl acetate, or propyl propionate; the conductive lithium salt is selected from one or more of lithium hexafluorophosphate, lithium bis(oxalate)borate, lithium difluoro(oxalato)borate, lithium perchlorate, lithium bis(trifluoromethanesulfonyl)imide, or lithium bis(fluorosulfonyl)imide.

In particular, its application as a high-voltage, high-temperature additive for lithium ion battery electrolytes improves the cycle stability of high-nickel ternary battery, high-voltage lithium cobalt oxide battery, and lithium manganese oxide battery.

The positive electrode material for lithium ion battery uses high-nickel ternary (LiNiₓCo_{y}Mn_{z}O₂, x+y+z=1, x≥0.6), lithium manganese oxide (LMO) or lithium cobalt oxide (LiCoO₂) system.

The present invention also protects a lithium battery, including a positive electrode sheet containing a positive electrode active material, a negative electrode sheet containing a negative electrode active material, a lithium battery separator and a lithium ion battery electrolyte, wherein the lithium ion battery electrolyte includes a lithium salt, an organic solvent and the amino-functionalized polysiloxane compound.

The beneficial effects of the present invention are as follows: The present invention provides a new amino-functionalized polysiloxane compound having moderate ionic conductivity, which can be used as an electrolyte additive in lithium ion battery. After only a small amount of the amino-functionalized polysiloxane compound according to the present invention is added to a commercial carbonate electrolyte, the impedance of the battery can be significantly reduced, the cycle life of the battery can be improved, and especially the high-temperature performance of the battery can be improved. The amino-functionalized polysiloxane compound according to the present invention can form a stable CEI film on the positive electrode surface, inhibit the hydrolysis of lithium hexafluorophosphate salt, reduce the generation of hydrofluoric acid, and thus effectively reduce the dissolution of metal ions. Especially in high-nickel ternary battery, high-voltage lithium cobalt oxide battery and lithium manganese oxide battery, this type of compound exhibits excellent performance and can significantly improve the long-term cycle stability of the battery.

### BRIEF DESCRIPTION OF THE DRAWINGS

FIG. 1 is an NMR hydrogen spectrum of the compound TS(EO)₂N of Embodiment 1;

FIG. 2 is an NMR carbon spectrum of the compound TS(EO)₂N of Embodiment 1;

FIG. 3 is an NMR hydrogen spectrum of the compound TS(EO)₁N of Embodiment 2;

FIG. 4 is an NMR carbon spectrum of the compound TS(EO)₁N of Embodiment 2;

FIG. 5 is an NMR hydrogen spectrum of the compound M-TS(EO)₁N of Embodiment 3;

FIG. 6 is a room temperature cycle performance test of NCM811/graphite battery in Embodiment 4 and Comparative Embodiment 1;

FIG. 7 is an impedance test of NCM811/graphite battery in Embodiment 4 and Comparative Embodiment 1;

FIG. 8 is a high temperature 60° C. cycle performance test of high voltage LCO/graphite battery in Embodiment 5 and Comparative Embodiment 2;

FIG. 9 is an impedance test of high voltage LCO/graphite battery in Embodiment 5 and Comparative Embodiment 2;

FIG. 10 is a high temperature 55° C. cycle performance test of the LMO/Li battery in Embodiment 6 and Comparative Embodiment 3;

FIG. 11 is an impedance test of LMO/Li battery in Embodiment 6 and Comparative Embodiment 3;

FIG. 12 is an SEM image of the LMO/Li battery after high temperature cycling in Embodiment 6 and Comparative Embodiment 3;

FIG. 13 is a room temperature cycle performance test of graphite/Li battery in Embodiment 7 and Comparative Embodiment 4; and

FIG. 14 is an impedance test of the graphite/Li battery in Embodiment 7 and Comparative Embodiment 4.

### DESCRIPTION OF THE EMBODIMENTS

The following is a further description of the present invention, but not a limitation of the present invention.

### Embodiment 1: Synthesis of TS(EO)₂N

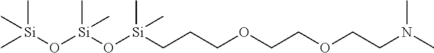

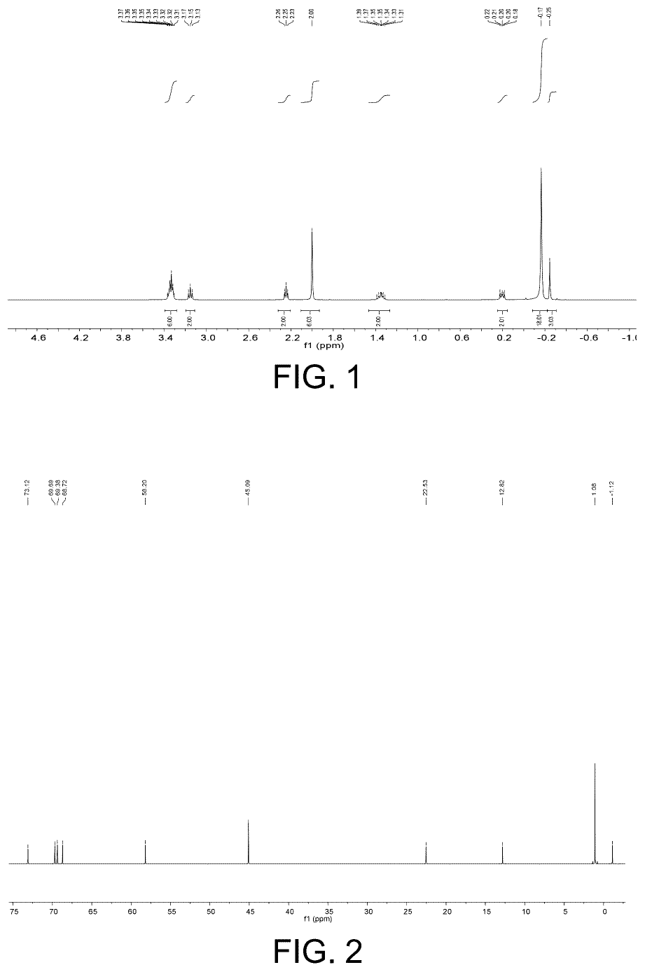

Under Ar atmosphere, N,N-dimethyl-2-[2-(2-propylene-1-yloxy) ethoxy]-ethylamine (51.9 g, 0.30 mol), 1,1,1,3,3,5,5-heptamethyltrisiloxane (70 g, 0.31 mol) and an appropriate amount of chloroplatinic acid were added to a 250 ml double-necked flask, and the reaction mixture was stirred at 90° C. for 24 h. After the reaction was completed, a colorless transparent liquid was obtained by multiple vacuum distillations with a yield of 75%. TS(EO)₂N (b.p.: 147° C., 3 mmHg). The nuclear magnetic ¹H-NMR and ¹³C-NMR spectra are shown in FIGS. 1-2, respectively.

TS(EO)₂N: ¹H-NMR (400 MHz, CDCl₃): δ 3.37-3.31 (m, 6H), 3.17-3.14 (t, J=6 Hz, 2H), 2.26-2.23 (t, J=6 Hz, 4H), 2.00 (s, 6H), 1.39-1.31 (m, 2H), 0.22-0.18 (m, 2H), −0.17 (s, 18H), −0.25 (s, 3H). ¹³C-NMR (100 MHz, CDCl₃): δ 73.1, 69.7, 69.4, 68.7, 58.2, 45.1, 22.5, 12.8, 1.1, −1.1. The conductivity test results are shown in Table 1.

TABLE 1

| Compound | σ/mS · cm⁻¹ (25° C.) |
|---|---|
| TS(EO)₁N | 0.21 |
| TS(EO)₂N | 0.20 |
| M-TS(EO)₁N | 0.18 |

### Embodiment 2: Synthesis of TS(EO)₁N

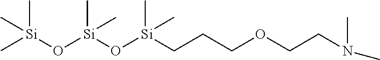

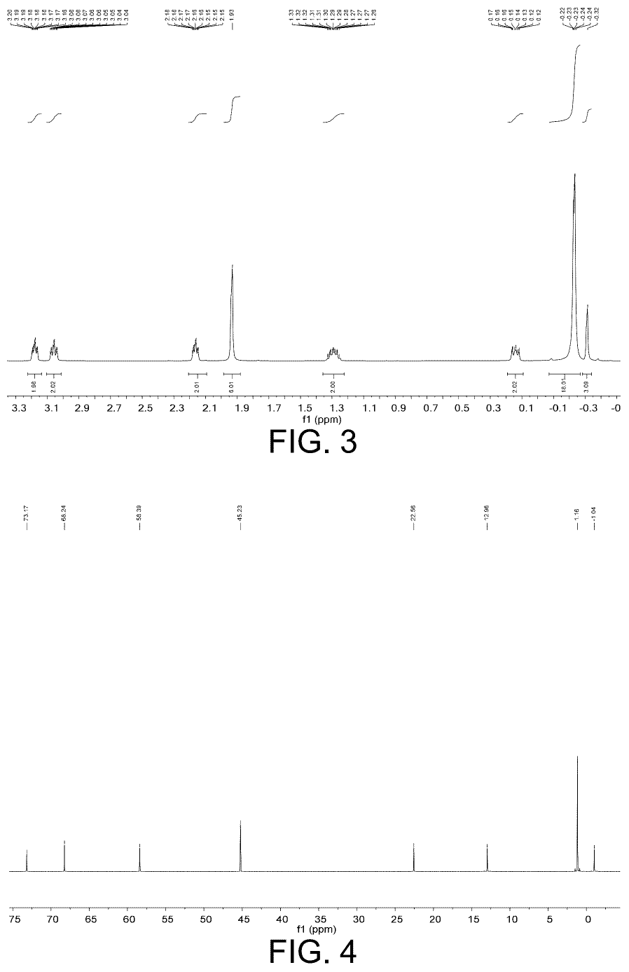

Under Ar atmosphere, N,N-dimethyl-2-propyl-2-enyloxyethanolamine (55.3 g, 0.43 mol), 1,1,1,3,3,5,5-heptamethyltrisiloxane (100 g, 0.45 mol) and an appropriate amount of chloroplatinic acid were added to a 250 ml double-necked flask and stirred at 90° C. for 24 h. After the reaction was completed, a colorless transparent liquid was obtained by multiple vacuum distillations with a yield of 75%. TS(EO)₁N (b.p.: 110° C., 1.95 mmHg). The nuclear magnetic ¹H-NMR and ¹³C-NMR spectra are shown in FIGS. 3-4. The conductivity test results are shown in Table 1.

TS(EO)₁N: ¹H-NMR (400 MHz, CDCl₃): δ 3.20-3.16 (m, 2H), 3.08-3.04 (m, 2H), 2.18-2.15 (m, 2H), 1.93 (s, 6H), 1.33-1.26 (m, 2H), 0.17-0.12 (m, 2H), −0.22-(−0.24) (m, 18H), −0.32 (s, 3H). ¹³C-NMR (100 MHz, CDCl₃): δ 73.2, 68.2, 58.4, 45.2, 22.6, 13.0, 1.16, −1.0.

### Embodiment 3: Synthesis of M-TS(EO)₁N

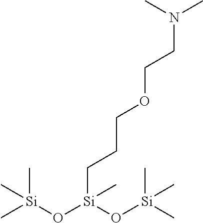

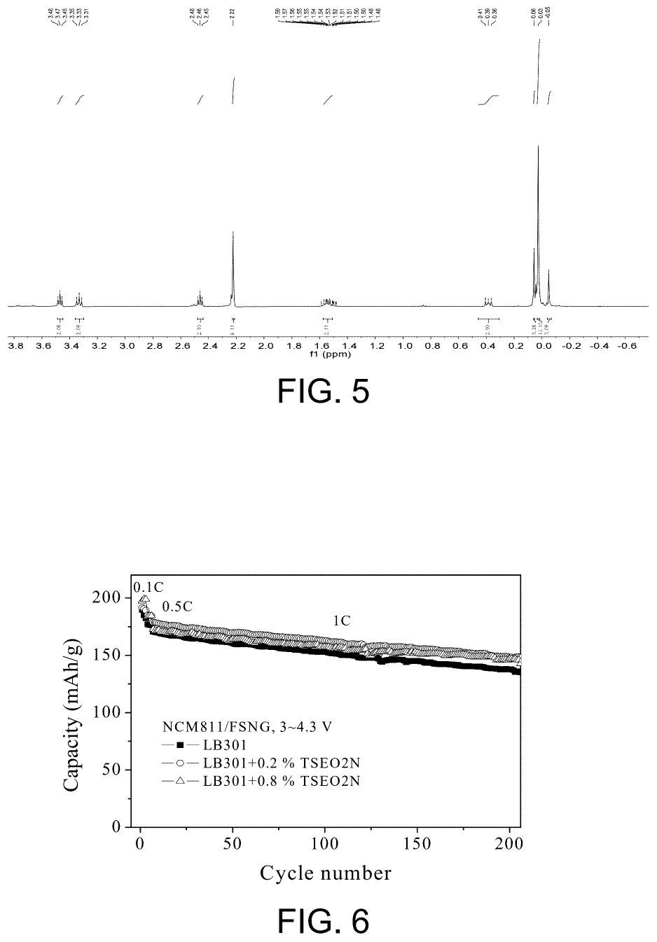

Under Ar atmosphere, N,N-dimethyl-2-propyl-2-enyloxyethanolamine (55.3 g, 0.43 mol), 1,1,1,3,5,5,5-heptamethyltrisiloxane (100 g, 0.45 mol) and an appropriate amount of chloroplatinic acid were added to a 250 ml double-necked flask, and the reaction mixture was stirred at 90° C. for 24 h under argon. After the reaction was cooled, a colorless transparent liquid was obtained by multiple vacuum distillations with a yield of 75%. (b.p.: 94° C./1.88 mmHg). The nuclear magnetic ¹H-NMR spectrum is shown in FIG. 5. The conductivity test results are shown in Table 1.

M-TS(EO)1N: 1H-NMR (400 MHz, CDCl3): δ 3.48-3.45 (t, J=6 Hz, 2H), 3.35-3.31 (t, J=8 Hz, 2H), 2.48-2.45 (t, J=6 Hz, 2H), 2.22 (s, 6H), 1.59-1.48 (m, 2H), 0.41-0.36 (m, 2H), 0.06 (s, 3H), 0.03 (s, 15H), −0.05 (s, 3H).

### Embodiment 4: The Compound TS(EO)₂N Synthesized in Embodiment 1 is Used as an Electrolyte Additive in NCM811/Graphite Battery

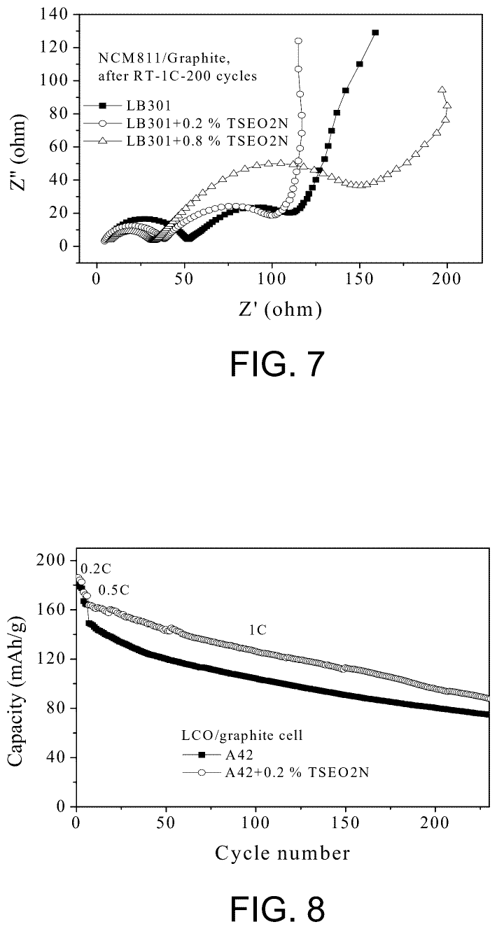

In a glove box filled with argon and containing less than 10 ppm of water and oxygen, a lithium ion battery electrolyte was prepared: 1 M LiPF₆/(EC:DMC:EMC (v:v:v=1:1:1) electrolyte was used as the basic electrolyte (LB301). Different contents of TS(EO)₂N compounds were added to the basic electrolyte to prepare electrolytes containing additives. Then, high-nickel ternary material LiNi_{0.8}Co_{0.1}Mn_{0.1} (NCM811) was used as the positive electrode, graphite was used as the negative electrode, and polyethylene film was used as the separator. Button battery (CR2025) were prepared using the above electrolytes. Specific battery testing method: At room temperature of 25° C., the NCM811/graphite battery was subjected to constant current charge and discharge tests on a Shenzhen Neware battery testing instrument. The charge and discharge cut-off voltage range was 3.0-4.3 V, and the charge and discharge current density was set to 0.1 C for 3 cycles, 0.5 C cycle for 3 weeks, and then 1 C charge and discharge cycle for 200 weeks. Battery impedance test method: After the battery cycle was completed, the AC impedance EIS was tested on a Shanghai Chenhua electrochemical workstation with an amplitude of 5 mV and a frequency range of 0.01 Hz~100k Hz. The test results are shown in FIGS. 6-7.

### Comparative Embodiment 1

Reference is made to Embodiment 4, and the difference lies in that that: the electrolyte used is the basic electrolyte LB301, which is 1 M LiPF₆ dissolved in a mixed solvent of EC/DMC/EMC (w/w/w=1:1:1), no other additives are added to this basic electrolyte.

The experimental results of Embodiment 4 and Comparative Embodiment 1 show that when the NCM811/graphite battery is cycled at 3.0-4.3 V and 1 C, the cycle capacity of the battery added with 0.2 wt % and 0.8 wt % TS(EO)₂N is significantly improved. After 200 cycles, the specific capacity of the battery without adding TS(EO)₂N is 134.9 mAh/g, and the specific capacity of the battery added with 0.2 wt % and 0.8 wt % TS(EO)₂N is 148.5 mAh/g and 142.7 mAh/g, respectively. After adding TS(EO)₂N, the battery cycle stability is increased from 79.1% to 83.1% and 82.6%, respectively (FIG. 6). The EIS test after cycling shows that the TS(EO)₂N additive significantly reduces the impedance of the NCM811/graphite battery membrane (FIG. 7).

### Embodiment 5: The Compound TS(EO)₂N Synthesized in Embodiment 1 is Used as an Electrolyte Additive in a High-Voltage LCO/Graphite Battery

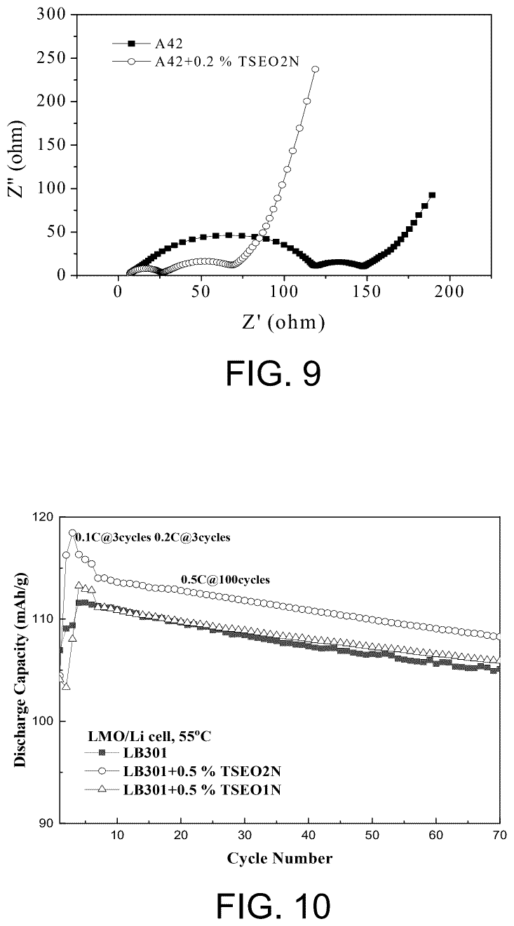

In a glove box filled with argon and containing less than 10 ppm of water and oxygen, a lithium ion battery electrolyte was prepared: an A42 electrolyte was used as the basic electrolyte. 0.2 wt % of TS(EO)₂N compound was added to the basic electrolyte to prepare an electrolyte containing additives. Then, using LCO as the positive electrode, graphite as the negative electrode, and polyethylene film as the separator, button battery (CR2025) were prepared using the above-mentioned electrolytes. Specific battery testing method: In a high-temperature box at 60° C., the LCO/graphite battery was subjected to constant current charge and discharge tests on a Shenzhen Neware battery testing instrument. The charge and discharge cut-off voltage range was 3.0-4.53 V, and the charge and discharge current density was set to 0.2 C for 3 cycles, 0.5° C. cycle for 3 weeks, and then 1 C charge and discharge cycle for 230 weeks. Battery impedance test method: After the battery was activated at room temperature and before high temperature test, the AC impedance EIS was tested on a Shanghai Chenhua electrochemical workstation with an amplitude of 5 mV and a frequency range of 0.01 Hz~100k Hz. The test results are shown in FIGS. 8-9.

### Comparative Embodiment 2

Reference is made to Embodiment 5, and the difference lies that the electrolyte used is the basic electrolyte A42, which is 1.15 M LiPF₆ dissolved in a mixed solvent of EC/DEC/PC/PP. This basic electrolyte contains additives such as FEC, but does not contain the amino-functionalized polysiloxane compound additive herein.

The experimental results of Embodiment 5 and Comparative Embodiment 2 show that when the LCO/graphite battery was cycled at 3.0-4.53 V and 1 C at a high temperature of 60° C., the cycle stability of the battery added with 0.2 wt % TS(EO)₂N was significantly improved. After 230 cycles, the specific capacity of the battery added with 0.2 wt % TS(EO)₂N is 85.9 mAh/g, while the specific capacity of the battery without adding TS(EO)₂N is 73.7 mAh/g. After adding TS(EO)₂N, the battery cycle stability increased from 49.5% to 52.5% (FIG. 8). After adding TS(EO)₂N, the impedance of the NCM811/graphite battery membrane was significantly reduced (FIG. 9).

### Embodiment 6: Application of the Compound TS(EO)₂N Synthesized in Embodiment 1 and the Compound TS(EO)₁N Synthesized in Embodiment 2 as Electrolyte Additives in High Temperature LMO/Li Battery

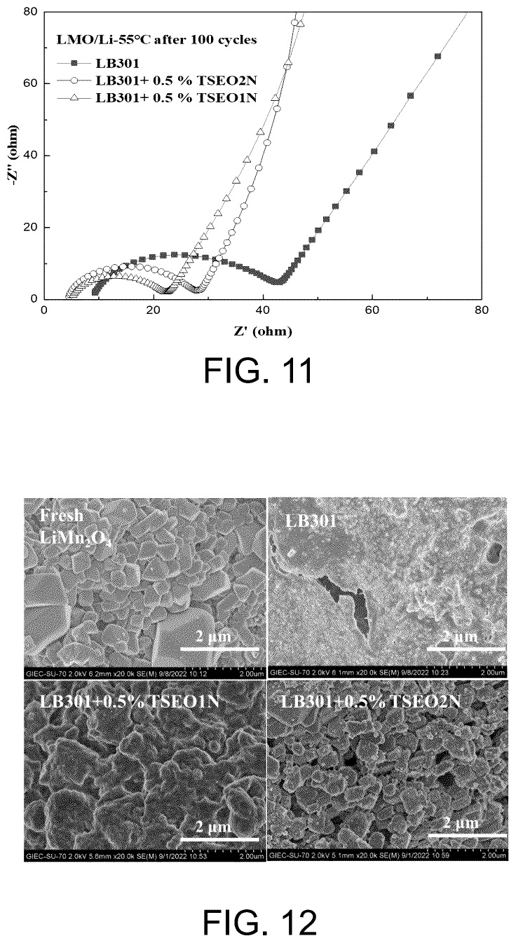

In a glove box filled with argon and containing less than 10 ppm of water and oxygen, a lithium ion battery electrolyte was prepared: 1 M LiPF₆/(EC:DMC:EMC (v:v:v=1:1:1) electrolyte was used as the basic electrolyte (LB301). 0.5% mass fraction of TS(EO)₂N and TS(EO)₁N compounds were added, respectively, to the basic electrolyte to prepare electrolytes containing additives. Then, button battery (CR2025) were prepared using the above electrolytes with LMO as the positive electrode, Li sheet as the negative electrode, and polyethylene film as the separator. The specific battery test method: In a high temperature box at 55° C., the LMO/Li battery was subjected to constant current charge and discharge test on a Shenzhen Neware battery test instrument. The charge and discharge cut-off voltage range was 3.0-4.0 V, and the charge and discharge current density was set to 0.1 C for 3 cycles, 0.5 C cycle for 3 weeks, and then 1 C charge and discharge cycle for 70 weeks. Battery impedance test method: After the battery cycle was completed, the AC impedance EIS was tested on a Shanghai Chenhua electrochemical workstation with an amplitude of 5 mV and a frequency range of 0.01 Hz~100k Hz. The test results are shown in FIGS. 10-11. The LMO/Li battery after high-temperature cycling was disassembled in the glove box, the surface of the LMO electrode was cleaned with DMC, and the SEM photos were taken with a thermal field emission scanning electron microscope, as shown in FIG. 12. The residual electrolyte and lithium sheet negative electrode after the battery was disassembled were collected, and the metal ion dissolution was tested by inductively coupled plasma emission spectrometer ICP-OES. The ICP sample preparation method is as follows: the lithium sheet was dissolved in deionized water and the residual electrolyte was reacted with nitric acid under heating conditions at 80° C. to remove organic matter, and then the metal ion dissolution was tested at a constant volume. The ICP test results are shown in Table 2.

### Comparative Embodiment 3

Reference is made to Embodiment 6, and the difference lies in that: the electrolyte used is the basic electrolyte LB301, which is 1 M LiPF₆ dissolved in a mixed solvent of EC/DMC/EMC (w/w/w=1:1:1), no other additives are added to this basic electrolyte.

The experimental results of Embodiment 6 and Comparative Embodiment 3 show that when the LMO/Li battery is cycled at a high temperature of 55° C., 3.0-4.0 V, 1 C, the cycle capacity of battery added with 0.5 wt % TS(EO)₂N is significantly improved, and the capacity of battery added with 0.5 wt % TS(EO)₁N was not significantly improved, but the capacity retention rate was slightly improved. After 70 cycles, the specific capacities of the battery added with 0.5 wt % TS(EO)₂N and 0.5 wt % TS(EO)₁N are 110.5 mAh/g and 107.7 mAb/g, respectively, while the specific capacity of the battery without adding additives is 106 mAh/g (FIG. 10). The EIS test after cycling shows that the additive significantly reduces the membrane impedance of the LMO/Li battery (FIG. 11). Before the LMO electrode cycle, the particle surface is smooth and the edges are clear. After high-temperature cycling, the surface of the LMO sheet in the LB301 battery is completely covered with thick electrolyte decomposition deposits, no LMO particles can be seen, and there are large cracks between the surface deposits. The surface of LMO particles added with 0.5 wt % TS(EO)₁N is covered with a thick surface film and electrolyte decomposition products. The LMO particles after adding 0.5 wt % TS(EO)₂N have clear shapes and are covered with a thin surface film, with only tiny particles of electrolyte decomposition products distributed (FIG. 12). SEM results show that the surface film formed by TS(EO)₂N has the best stabilizing effect on the LMO surface. The ICP test of Mn metal dissolution in LB301 battery after high temperature cycling is 10.05 mg L⁻¹. The amount of ion metal dissolved in the battery added with 0.5 wt % TS(EO)₁N was reduced to 7.1 mg L⁻¹. However, the amount of metal ions dissolved in the battery added with 0.5 wt % TS(EO)₂N was significantly reduced to only 2.1 mg L⁻¹, which is one fifth of that in LB301 (Table 2). The above results show that the additive effectively reduces the metal ion dissolution of the LMO electrode and is beneficial to improving the cycle stability of the battery, which is consistent with the battery test results.

TABLE 2

| | Mn ion dissolution |
|---|---|
| Electrolyte | amount (mg L⁻¹) |
| LB301 | 10.05 |
| LB301 + 0.5% TS(EO)₁N | 7.1 |
| LB301 + 0.5% TS(EO)₂N | 2.1 |

### Embodiment 7: Application of the Compound TS(EO)₂N Synthesized in Embodiment 1 and the Compound TS(EO)₁N Synthesized in Embodiment 2 as Electrolyte Additives in Graphite/Li Battery

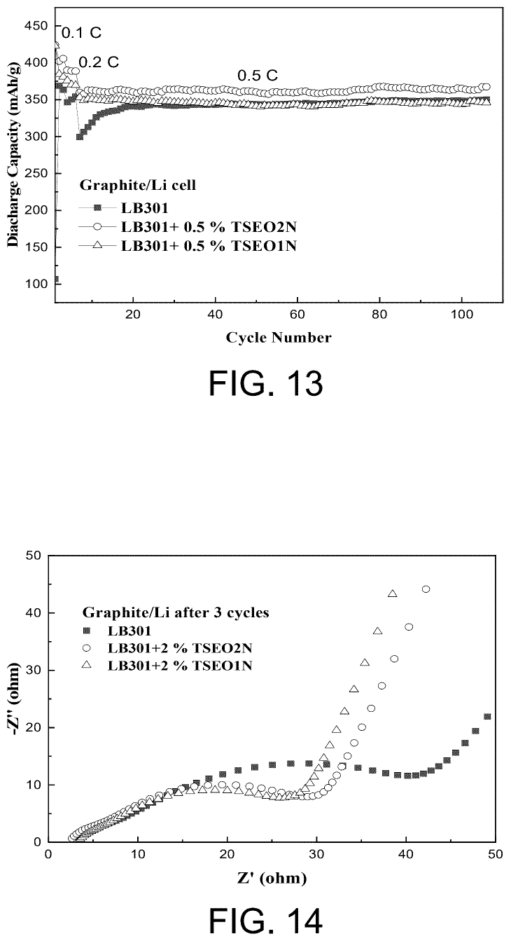

In a glove box filled with argon and containing less than 10 ppm of water and oxygen, a lithium ion battery electrolyte was prepared: 1 M LiPF₆/(EC:DMC:EMC (v:v:v=1:1:1) electrolyte was used as the basic electrolyte (LB301). 0.5% mass fraction of TS(EO)₂N and TS(EO)₁N compounds were added, respectively, to the basic electrolyte to prepare electrolytes containing additives. Then, button battery (CR2025) were prepared using the above electrolytes with Li sheet as the positive electrode, graphite as the negative electrode, and polyethylene film as the separator. Specific battery test method: At room temperature of 25° C., the graphite/Li battery was subjected to constant current charge and discharge test on a Shenzhen Neware battery test instrument. The charge and discharge cut-off voltage range was 0.01-3 V, and the charge and discharge current density was set to 0.1 C for 3 cycles, 0.2 C for 3 cycles, and then 0.5 C for 100 cycles. Battery impedance test method: After the battery cycle, the AC impedance EIS was tested on a Shanghai Chenhua electrochemical workstation with an amplitude of 5 mV, the frequency range is 0.01 Hz~100k Hz. The test results are shown in FIG. 13-14.

### Comparative Embodiment 4

Reference is made to Embodiment 7, the difference lies in that: the electrolyte used is the basic electrolyte LB301, which is 1 M LiPF₆ dissolved in a mixed solvent of EC/DMC/EMC (w/w/w=1:1:1), no other additives are added to this basic electrolyte.

The experimental results of Embodiment 7 and Comparative Embodiment 4 show that: for graphite/Li battery in 0.5 C cycle, the initial capacity of the battery without adding additives in Comparative Embodiment 4 is only 300 mAh/g, indicating that the battery performance is unstable when converted to high rate, the initial cycle capacity of the battery added with 0.5 wt % TS(EO)₂N was significantly increased to 360 mAh/g, and the initial capacity of the battery added with 0.5 wt % TS(EO)₁N was increased to 340 mAh/g. After 100 cycles, the battery specific capacity of the battery added with 0.5 wt % TS(EO)₂N and 0.2 wt % TS(EO)₁N is almost unchanged (FIG. 13). EIS test after cycling shows that the additive significantly reduces the impedance of graphite/Li battery membrane (FIG. 14).

1. An amino-functionalized polysiloxane compound represented by formula I: 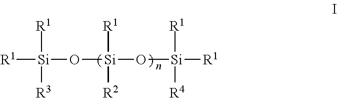
wherein n=an integer of 1 to 4, R¹ is selected from any one of C1-C5 alkyl and alkoxy; R², R³ and R⁴ are selected from alkyl, alkoxy, and —(CH₂)₃(OCH₂CH₂)ₓN(CH₃)₂, wherein x=1-3, and R², R³ and R⁴ must have a group selected from —(CH₂)₃(OCH₂CH₂)ₓN(CH₃)₂.

2. A use of the amino-functionalized polysiloxane compound according to claim 1, wherein the amino-functionalized polysiloxane compound is used as a material of an electrolyte for a lithium ion battery, a sodium ion battery, a potassium ion battery, a lithium sulfur battery or supercapacitors.

3. The use according to claim 2, wherein the electrolyte of the lithium ion battery, sodium ion battery, potassium ion battery, lithium sulfur battery or supercapacitor comprises a lithium salt, an organic solvent and the amino-functionalized polysiloxane compound.

4. The use according to claim 3, wherein a concentration of the lithium salt in the electrolyte is 0.5-1.5 mol/L, and an amount of the amino-functionalized polysiloxane compound used is 0.1-5% of a total mass of the lithium salt and the organic solvent.

5. The use according to claim 3, wherein the organic solvent is selected from one or more of ethylene carbonate, dimethyl carbonate, ethyl methyl carbonate, diethyl carbonate, propylene carbonate, fluoroethylene carbonate, ethyl acetate, or propyl propionate; and the lithium salt is selected from one or more of lithium hexafluorophosphate, lithium bis(oxalate)borate, lithium difluoro(oxalato)borate, lithium perchlorate, lithium bis(trifluoromethanesulfonyl)imide, and lithium bis(fluorosulfonyl)imide.

6. A lithium ion battery, comprising the electrolyte according to claim 3.

7. A sodium ion battery, comprising the electrolyte according to claim 3.

8. A potassium ion battery, comprising the electrolyte according to claim 3.

9. A lithium sulfur battery, comprising the electrolyte according to claim 3.

10. A supercapacitor, comprising the electrolyte according to claim 3.
